(19) United States
(12) Patent Application Publication
(10) Pub. No.: US 2004/0188011 A1
(43) Pub. Date: Sep. 30, 2004

(54) Method of making a prosthetic bearing element

(75) Inventor: Eric Jones, Limerick (IE)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Howmedica International S. DE R.L., Limerick (IE)

(21) Appl. No.: 10/793,116

(22) Filed: Mar. 4, 2004

(30) Foreign Application Priority Data
Mar. 5, 2003 (GB) 0305021.8

(51) Int. Cl. B32B 31/00

(52) U.S. Cl. 156/272.8; 623/901

(57) ABSTRACT

A method of making a prosthetic polymeric bearing element having a backing made from a “rigid” polymeric bearing material which has a minimum hardness value of 65 N/mm² and which supports a bearing liner having a bearing surface and made from a “soft” elastomeric polyurethane material having a hardness value of 3.0 to 9.0 N/mm² (using machine testing method BS 2782; Pt3 method 365D). The opacity of said bearing liner is arranged to allow the passage of a laser beam through it and the opacity of said backing is arranged to prevent the passage of a laser beam which has passed through the bearing liner. The liner and backing are then bonded together and then the bearing liner and backing are treated with the laser beam to cause an improved interfacial bond by laser welding.

### BACKGROUND OF THE INVENTION

This invention relates to a method of making a prosthetic bearing element and to elements made by such a process. More particularly, it relates to a way to improve the bond between two polymeric elements making up the prosthetic bearing as well as ways to test the bond.

U.S. Pat. No. 5,879,387 describes a prosthetic bearing element which comprises a backing supporting a bearing liner having a bearing surface.

The backing is said to be made from a rigid polymeric material which has a minimum hardness value of 65 N/mm² and the bearing liner is made from a “soft” elastomeric polyurethane material having a hardness value of 3.0 to 9.0 N/mm². The specification describes typical material which can be used for these bearings and a way of fabricating them by injection molding. The particular construction allows a method for the attachment of this type of bearing element that may be held in a metal support if required and the construction is robust to reduce the amount of penetration and creep when the element is subjected to loads through the femoral component of either a hip or a knee. The bearing could be used in other joints such as, for example, a shoulder.

The injection molding process employed in U.S. Pat. No. 5,879,387 was fully explored by the applicants to describe the range of molding conditions that were acceptable and as a result the present applicants have now developed a process which provides improved properties. The teachings of U.S. Pat. No. 5,879,387 are incorporated herein by reference.

### SUMMARY OF THE INVENTION

According to the present invention a method of making a prosthetic bearing element which comprises a backing made from a “rigid” polymeric bearing material which has a minimum hardness value of 65 N/mm² and which supports a bearing liner having a bearing surface and made from a “soft” elastomeric polyurethane (PU) material having a hardness value of 3.0 to 9.0 N/mm² (using machine testing method BS 2782; Pt3 method 365D). The backing and liner are characterized in that the liner is transparent to certain laser light and the opacity of the backing is arranged to prevent the passage of a laser beam which has been passed through the bearing liner, bonding the backing to the bearing liner and then treating the bearing liner and backing with the laser beam to cause improved fusion between the two by laser welding.

Thus the technique can be applied to achieve improved in interface properties of surface substrates bonded to the soft polyurethane bearing surface and a method of improving interfacial bonding of the system set forth in U.S. Pat. No. 5,879,387 in areas that are subjected to high stress levels.

The preferred method is to produce a composite material for the backing, from a hard PU and fiber such as carbon, Kevlar, glass or filler such as hydroxylapatite, barium sulphate, zirconia, although this list is not exclusive.

In a preferred method, a hard (75D) commercial grade of polyurethane was filled with a carbon fiber for use as a backing.

A low power laser beam can be used to scan over the bearing surface. The energy passes directly through the bearing surface provided that the liner material is clear enough and is relatively unaffected, but is absorbed at the interface when it meets the darker composite layer of the backing. This energy is transformed into heat and results in local fusion. The overall result is that the interface bonding strength is increased.

### BRIEF DESCRIPTION OF THE DRAWINGS

The invention can be performed in various ways and some embodiments will now be described by way of example and with reference to the accompanying drawings in which:

FIG. 1 shows the use of a composite backing on a polyurethane (PU) bearing surface which surface exhibits low frictional properties;

FIG. 2 is similar to FIG. 1 but includes standard ultra-high molecular weight polyethylene as a comparison;

FIG. 3 is a graph showing an estimation of fusion bond thickness measured by Fourier Transform Infra red Spectroscopy (FTIR);

FIG. 4 is a diagrammatic view of a prosthetic bearing cup showing examples of rupture of the fusion between backing and wear surface layers;

FIG. 5 shows a graph showing typical peel strength values after soaking in Ringer's solution at 37° C.;

FIG. 6 shows a graph showing typical peel strength values of a dry bearing; and

FIG. 7 is a graph showing the stability of laser assisted fusion bond after short-term ageing.

### DETAILED DESCRIPTION

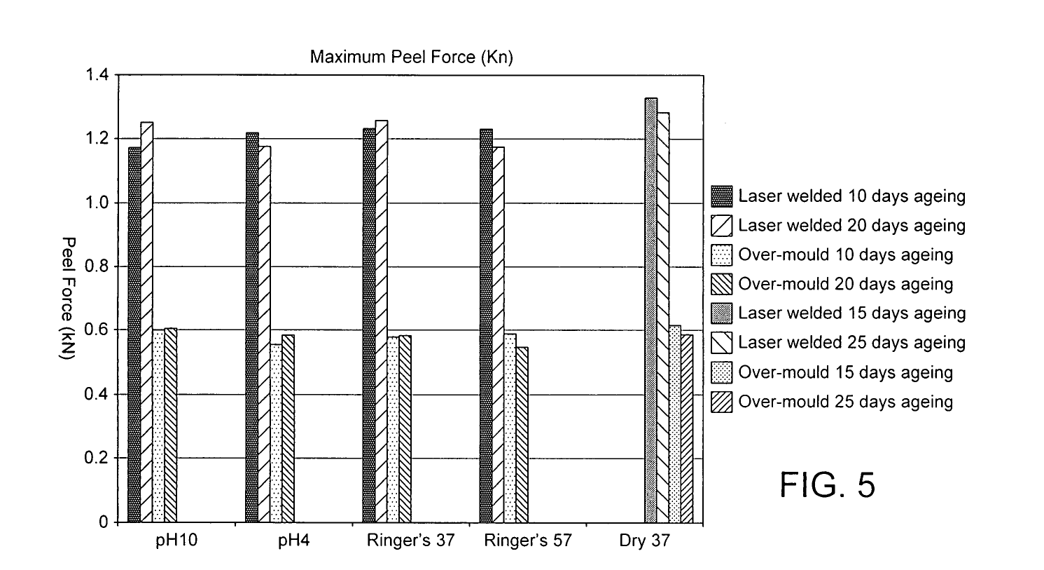

As referred to above, the injection molding process of U.S. Pat. No. 5,879,387 was fully explored to describe the range of molding conditions that were acceptable. Of particular interest was the strength of the bone between the bearing and support layers. This interface is highly stressed during the various loading regimes encountered during the walking cycle, and is liable to fail unless maximum fusion between the two materials is achieved. The extent of this fusion was assessed by carrying out a detailed peel strength series of experiments using thicknesses equivalent to those of the actual bearing. Another method used was the estimation of the extent of this fusion layer using FTIR. As shown in FIGS. 5 and 6 the combination of the hard and soft polyurethane resin described gave the best peel strength values. Bonding of other polymers, including ultra-high molecular weight polyethylene (UHMWP), composites and metals did not achieve interface strengths high enough to sustain the shear forces developed during simulated wear testing.

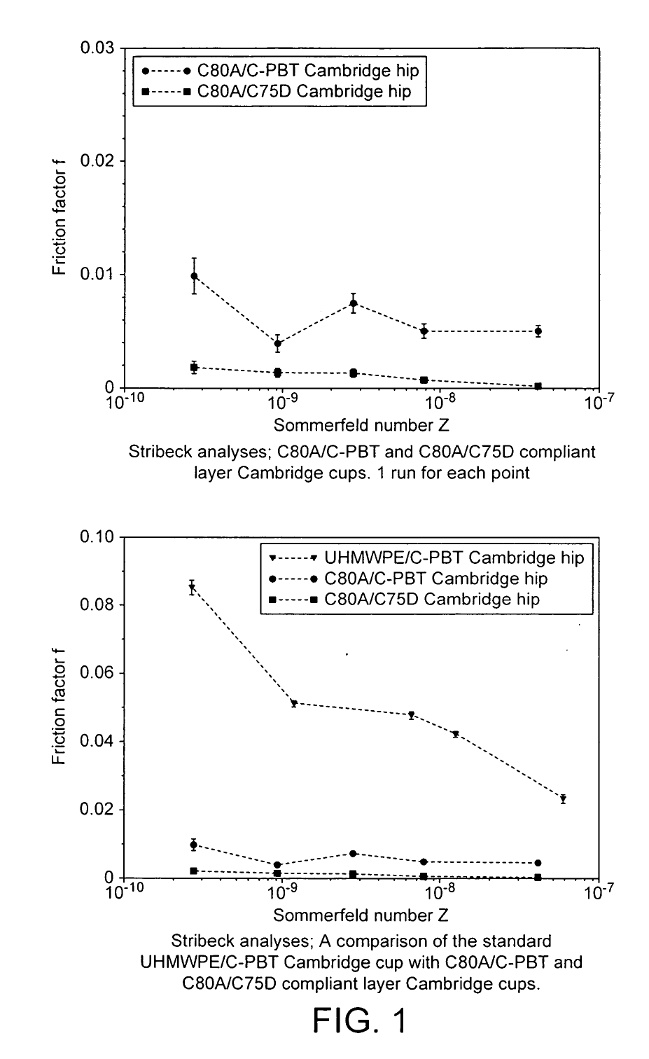

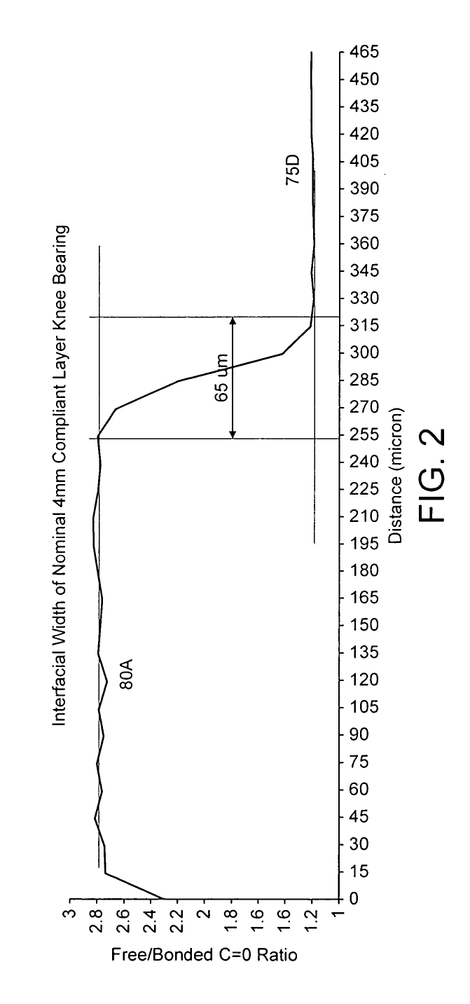

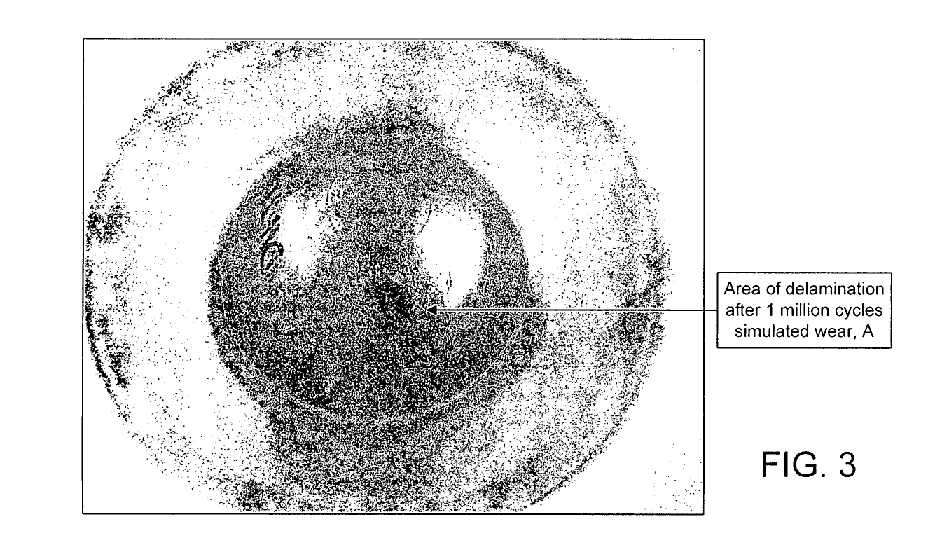

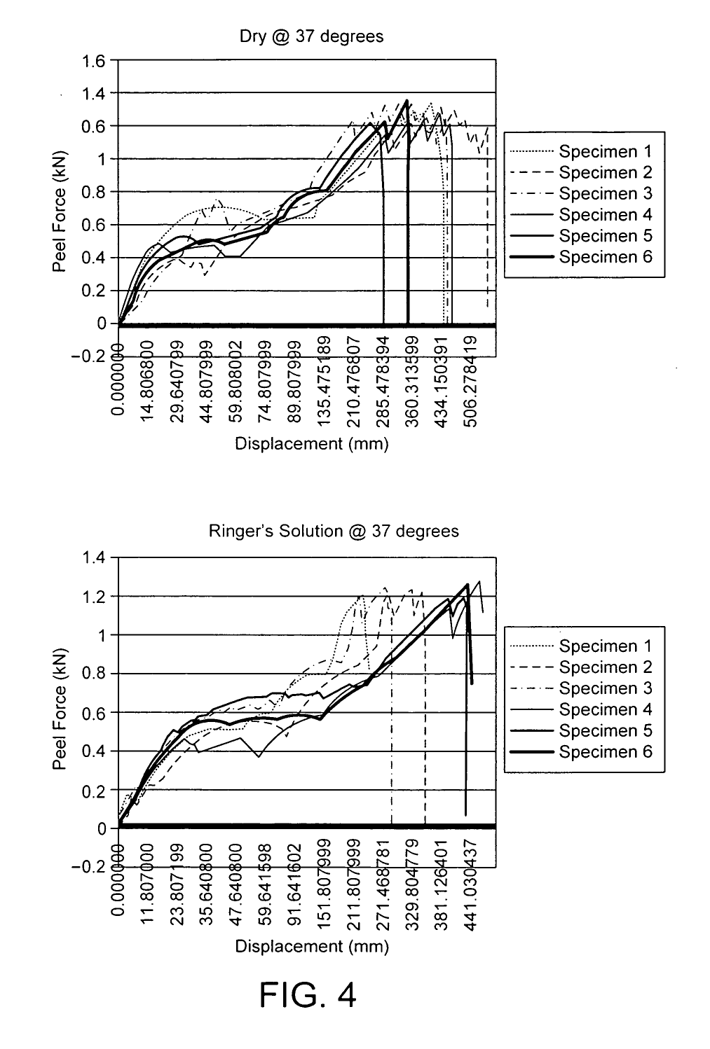

Auger et al. (DD Auger et al. Proc Instn Mech/engrs Vol. 209, 1995, 83-91) reported such findings in a series of simulated wear tests on knee bearings. Interfacial debonding occurred in many of the samples tested because the bonding between the bearing material (polyurethane) and the substrate (titanium) was insufficient. The applicants carried out a series of tests using a composite substrate to a polyurethane bearing, and the interface failed quickly (less than 10,000 cycles). FIG. 1 shows how the composite construct is able to function with superior performance, but only in the short term. In very rare instances the applicants' preferred option failed when extreme testing conditions have been used. FIG. 3 shows an example of such a failure seen in a knee bearing during wear simulated testing and using a misaligned bearing to give a worse case scenario. The area of delamination after 1 million cycles of simulated wear being indicated by reference letter A.

U.S. Pat. No. 5,879,387 refers to optimum bonding being approached using the hard and soft polyurethanes referred to. In certain instances however it may be preferred to have the backing a little stiffer such that the backing may be reduced in thickness, or the stiffer and harder material may reduce the extent of creep, or the water absorption may be reduced for and other reasons also. However, when such materials are used in the interfacial bonding strength is compromised. Increasing the stiffness can be significantly effected either by changing the existing PU hard backing or inclusion of a stiffer medium.

The method according to the present invention can be applied to achieve improvement in interface properties of stiffer substrates bonded to the soft polyurethane bearing surface, and a method of improving the interfacial bonding of the method set forth in U.S. Pat. No. 5,879,387 (soft PU bearing and hard PU backing) in areas that are subjected to high stress levels.

A preferred method according to the present invention is to produce a composite material for the backing, from the hard PU and a fiber such as carbon, Kevlar, glass, or filler such as hydroxylapatite, barium sulphate, zirconia, although this list is not mutually exclusive.

In a method to be investigated, hard polyurethane (Bionate 75D) was filled with carbon fibers (Solartrim) to the extent of 15%.

Melt compounding was used to mix in the carbon fibers that were of staple length 6-mm, prior to injection molding. All compounding took place using a Prism TSE16 twin-screw extruder. The extruder had co-rotating twin screws with intermeshing flights. The screws were 16-mm in diameter with a compression ratio of 15:1 (length/diameter ratio). The extent of shear required was optimized by modifying the various screw configures. For the material studied, the extruder temperature profile was set at:

| | |
|---|---|
| Die | 220° C. |
| Zone 4 | 220° C. |
| Zone 3 | 210° C. |
| Zone 2 | 205° C. |
| Zone 1 | 195° C. |

The torque was set to 12.6-13.9 Nm (55%). The material was hauled off at the rate of 3 m/minute, and chopped into pellets of length suitable for injection molding.

In order to test the invention, standard peel tests were made as discussed in U.S. Pat. No. 5,879,387. The following molding conditions were employed to produce this backing using a standard 70T Arburg injection molding machine.

| | |
|---|---|
| Temperature Profile | 230, 230, 225, 210° C. |
| Mold temperature | 30° C. |
| Injection Pressure | 50 bar |
| Holding Pressure | 25 bar |
| Injection time | 10 secs |
| Hold time | 20 secs |
| Cooling time | 50 secs |
| Injection speed | fast |

This carbon fiber filled hard PU composite material now acts as the backing or support material, and a soft polyurethane (Bionate 80A) was injection molding over one surface using the following conditions.

| | |
|---|---|
| Temperature Profile | 220, 220, 215, 200° C. |
| Mold temperature | 20° C. |
| Injection Pressure | 50 bar |
| Holding Pressure | 25 bar |
| Injection time | 3 secs |
| Hold time | 10 secs |
| Cooling time | 20 secs |
| Injection speed | fast |

This produced a construction that permits other design options to be considered. The strength of the interface is, however, reduced in comparison to the all-pure PU system, and would therefore be likely to fail in service. However, a method of improving this interface has been developed using laser technology. A low power laser beam is scanned over the bearing surface. The energy passes directly through the clear layer relatively unaffected, but is absorbed at the interface when it meets the dark composite layer. This energy is transferred into heat and results in local fusion. It may be necessary to impart pressure to the device to ensure proper consolidation of the interface. The net result is that the interface bonding strength is increased to the level as recorded for the all pure PU system (see FIGS. 5, 6 and 7). It will be appreciated that the opacity of the bearing liner is such as to allow the laser beam to pass through it but the backing opacity is sufficient to prevent passage of the beam.

A further composite backing construction was developed by alloying thermoplastic resins or thermoplastic composites with the PU materials. In a separate series of experiments, a composite was formed from carbon fiber reinforced polybutyleneterephthalate (PBT) blended with hard PU resin. The new composite materials for evaluation were a blend of Biothane 75D with 30% carbon fiber reinforced polybutylenetercphthalate at levels of 70/30, 80/20 and 90/10% respectively. Prior to processing in the extruder as previously described, the blends were tumble mixed by shaking in a plastic container for 5 minutes.

For all three blends of material studied, the extruder temperature profile was set at:

| | |
|---|---|
| Die | 220° C. |
| Zone 4 | 220° C. |
| Zone 3 | 210° C. |
| Zone 2 | 205° C. |
| Zone 1 | 195° C. |

The torque was set to 14.1-15.1 Nm (60%). The material was hauled off at the rate of 3-4 m/minute, and chopped into pellets of length suitable for injection molding.

In order to test the invention, standard peel test samples were made as previously reported in U.S. Pat. No. 5,879,387. The following molding conditions were employed to produce this backing using a standard 70T Arburg, injection molding machine:

| | |
|---|---|
| Temperature Profile | 230, 230, 225, 210° C. |
| Mold temperature | 30° C. |
| Injection Pressure | 50 bar |
| Holding Pressure | 25 bar |
| Injection time | 10 secs |
| Hold time | 20 secs |
| Cooling time | 50 secs |
| Injection speed | fast |

This carbon fiber filled hard PU composite material now act as the backing or support material, and a soft polyurethane (Bionate 80A) was injection molding over one surface using the following conditions:

| | |
|---|---|
| Temperature Profile | 225, 220, 215, 200° C. |
| Mold temperature | 30° C. |
| Injection Pressure | 50 bar |
| Holding Pressure | 25 bar |
| Injection time | 3 secs |
| Hold time | 10 secs |
| Cooling time | 20 secs |
| Injection speed | fast |

The fused interface was, however, reduced, with a subsequent reduction in the bonding strength (to a lower level than in the previous example). This interfacial bond strength was, however, increased by using laser scanning in the method described above.

It is also possible to use just a thermoplastic composite as the backing material. This was tried as shown in FIGS. 5 and 6 when the interfacial bond strength was clearly inadequate (failed early). Although there is some type of adhesion between the composite backing and bearing surface, it is likely that these are attractive forces similar to Van der Waal forces of physical attraction. Such forces are weak, and are not able to sustain any prolonged activity under load. The bond can be improved again using the laser scanning process whereby heat is generated at the interface. The type of thermoplastic is of importance as this governs the conditions used and the extent of bonding.

In the applicants' example carbon-fiber-reinforced polybutyleneterephthalate (CFRPBT) was used which has a melting point close to that of the PU, and bond strength was good. The task is more difficult as the melting point difference increases, so that the use of carbon-fiber-reinforced polyetheretherketane (CFRPEEK) is more problematic.

Fillers can also be incorporated into the matrix of the PU to increase rigidity, and also impart further design possibilities. For example, hydroxylapatite was blended with the PU, which in addition to increase the stiffness, also provided the possibility of increasing osteoactivity on the backing. Again, this process disimproved the interfacial bond strength, but this could be improved with laser scanning. In this case it may be necessary to add an energy absorber in the form of an infra red sensing pigment either into the initial molding compound or to the surface of one of the components prior to over-molding. This approach is also valid for the two pure polymers if additional bond strength is required in areas of high stress.

Improvements in interfacial bonding of these composite constructions are only of benefit if the effect is sustained in aqueous environment. A series of studies was effected on one of the samples to determine the stability of the interface. FIG. 7 highlights these results and shows that at least over the short term the aging is not significant.

The required relative opacities of the liner and the backing can be obtained by the use of appropriate fillers or as described above or infra red dues, typically as referenced by Sevedenko MM “Determined Spectral characteristics of pigment absorption and scattering in the middle T/R spectral range.” Optics and Spectroscopy Vol. 76, 3 (1994) 418-420.

Diode or Nd:YAG laser welding methods were found to be most suitable. Due to the composite carbon filler in the polyurethane composite material in the examples tested, this material has excellent laser absorbent properties, therefore the standard diode laser welding method was the most suited welding method to be employed. A very small test sample was welded with different laser welding techniques, in order to validate the literature findings. Results from these initial tests indicated that diode laser welding gave the strong bond, without causing deformation of the specimen material.

### EXAMPLES

Further analysis of the diode laser welding method on the sample specimen, revealed critical clamping forces, beam width, welding speed and welding power. A total of eight different welds were carried out, altering the critical parameters for each laser weld. It can be seen from the results of these eight trial welds, see Table 1, the impact of the critical welding parameters on the joint. Weld 1 was a focused weld, due to the beam width, overall joint strength was reasonable, but due to the intensity of the weld, burning of the polyurethane was found. Weld 2 had similar parameters to weld 1 but, due to the lower welding speed, more burning of the polyurethane material was found, thus a decrease in joint strength. When the beam width was increased in weld 3, the clamp pressure was also increased, this gave a stronger weld with less burning of the polyurethane.

Learning from the previous welds, clamp pressure was increased in weld 4, again less burning found and bond strength increased. Having increased the clamp pressure and reduced the laser power, optimum welds were found in welds 5 and 6. Other welding was carried out by increasing the laser power and welding speed proportionally. This was considered as a time saving exercise in welding, and therefore a reduced welding cost. However, results from welds 7 and 8, which were carried out at high speed and power, gave very poor weld and severe burning of the polyurethane. The sample laser welding test provided an excellent incite into the optimum parameters required in the welding of the main batch of specimen, which were aged and peel tested. Upon analysis of this sample weld, the main batch of specimens were welded at optimum laser welding conditions.

| | Beam | Clamp | | Welding | |
|---|---|---|---|---|---|
| | width | pressure | Power | speed | |
| No. | (mm) | (psi) | (W) | (mm/mm) | Results |
| 1 | 5 | 50 | 10 | 200 | Reasonable strength bond, |
| | | | | | burning |
| 2 | 5 | 50 | 10 | 180 | Poor bond strength, burning |
| 3 | 8 | 60 | 10 | 150 | Good weld, wide track |
| 4 | 8 | 70 | 10 | 150 | Good weld, strong bond |
| 5 | 8 | 80 | 9 | 140 | Excellent weld, excellent |
| | | | | | bond |
| 6 | 8 | 90 | 9 | 140 | Excellent weld, excellent |
| | | | | | bond |
| 7 | 5 | 50 | 150 | 2500 | Burning, poor weld |
| 8 | 5 | 50 | 150 | 3000 | Burning, poor weld |

A total of five ageing procedures were selected for the welded specimen. A total of twenty-eight specimens were welded at optimum laser welding conditions. Six of each specimen were assigned randomly to three of the ageing processes and five specimens assigned to two of the ageing processes. Due to the relatively short ageing time available, three of the ageing methods were accelerated ageing. The first set of specimens were stored in dry sealed conditions at room temperature, these specimens were comparison specimens, this allowed other aged specimens to be evaluated for ageing. Three of these specimens were peel tested 15 days after welding and three specimens 25 days after welding.

Ageing at 37° C. in Ringer's solution, was carried out on one set of specimens in order to simulate human host conditions. These specimens were immersed in Ringer's solution, and placed into a temperature controlled covered water bath. These conditions gave a humid environment, where the Ringer's solution had very little evaporation and concentration was not altered. Alternatively, a temperature controlled oven could have been employed, but significant evaporation of the Ringer's solution would have been experienced and concentration of the solution altered. Three specimens were removed from the Ringer's solution after 10 days and peel tested. The remaining specimens were removed from the Ringer's solution after 20 days and also peel tested.

Accelerated ageing was carried out in three different methods. Accelerated aging at 57° C. was carried out in Ringer's solution. Having increased the temperature by 20° C. over the host environment temperature, ageing was accelerated by approximately four times the standard rate. This allowed the prediction of long term ageing effects on the joint bond, in a relatively short period of time. The environment temperature was again maintained by employing a temperature controlled water bath. The water bath was again selected for the same benefits outlined of the ageing of specimen at 37° C. in Ringer's solution. After a period of 10 days ageing in the described environment, three of the specimens were peel tested, due to the accelerated ageing this was the equivalent to 40 days ageing in the host environment conditions. The remaining three specimens were peel tested after 20 days of ageing, again due the acceleration this ageing period was equivalent to 80 days of ageing at the host environment conditions.

Due to the variations of acid and alkaline concentrations in the human body, due to diet, stress and other factors, extreme conditions were simulated in accelerated ageing. Five specimens were immersed in a phosphate buffered solution with a pH level of four. This would at lest simulate the worse case acidic conditions in the regions of body fluids, where this material bond would be utilized in total joint replacements. The immersed specimens were placed in an enclosed temperature controlled water bath at 37° C. Peel testing was carried out on two of the specimens after 10 days ageing, the further three remaining specimens were peel tested after 20 days of ageing.

Finally, the fifth set of specimens were immersed in a phosphate buffered solution with a pH level of ten. After 10 days ageing in this environment, two specimens were peel tested. The remaining three specimens were peel tested after 20 days. Since body fluids in the region of total joint replacements can vary in pH concentration, both acid and alkaline pH levels were simulated. In normal situations the body fluid in total joint regions would vary from pH of 5 to 8, this depends on diet, stress, injury to the local tissue and many other factors. Therefore, the pH levels selected in these ageing processes are greater than those found in tissue body fluids.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for increasing the interface bone between a bearing backing and a bearing liner attached thereto comprising:
forming a bearing liner from a polymeric material transparent to a laser beam;
forming a bearing backing opaque to said laser beam; and
bonding said backing to said liner by scanning at least part of an interface surface between said liner and said backing with said laser.

2. The method as set forth in claim 1 wherein said backing is made of a carbon fiber filled polyurethane having a hardness of at least 65 N/mm².

3. The method as set forth in claim 2 wherein the backing has 15% to 30% carbon fiber.

4. The method as set forth in claim 2 wherein the carbon fiber had an average length of 6 mm.

5. The method as set forth in claim 1 wherein the liner is a polyurethane having a hardness of 3.0 to 9.0 N/mm².

6. The method as set forth in claim 1 wherein the laser has a power of about 9 to 10 watts and a beam width of about 8 mm.

7. A method of making a prosthetic bearing element which comprises a backing made from a “rigid” polyurethane bearing material which has a minimum hardness value of 65 N/mm² and which supports a bearing liner having a bearing surface and made from a “soft” elastomeric polyurethane material having a hardness value of 3.0 to 9.0 N/mm² (using machine tested method BS 2782; Pt3 method 365D) comprising forming a bearing liner at least partially transparent to a laser beam forming a bearing liner at least partially transparent to a laser beam forming a bearing backing at least partially opaque to the laser beam and bonding the backing to the bearing liner and then treating an interface between the bearing liner and backing with said laser beam to cause improved bonding by laser welding.

8. The method as set forth in claim 7 wherein a composite material is produced for the backing which includes a fiber or filler.

9. The method as set forth in claim 8 wherein said fiber is carbon, Kevlar, glass, and said filler is hydroxylapatite, barium sulphate, zirconia or a combination thereof.

10. The method as set forth in claim 9 wherein said composite material is a hard (75D) commercial grade of polyurethane filled with a carbon fiber.

11. The method as set forth in claim 10 wherein the carbon fiber is of various fiber lengths and compositions.

12. The method as set forth in claim 11 wherein said composite backing material is formed by alloying thermoplastic resins or thermoplastic composites with the “rigid” polyurethane material.

13. The method as set forth in claim 12 wherein said composite is formed from carbon fiber reinforced polybutyleneterephthalate blended with “rigid” polyurethane resin.

14. The method as set forth in claim 7 wherein said backing material is a thermoplastic composite.

15. The method as set forth in claim 7 further comprising using filters or infra red dyes to obtain the relative opacities of the bearing liner and backing.

16. The method as set forth in claim 15 wherein the infra red dye is Sevedenko MM.

17. The method as set forth in claim 7 wherein a diode or Nd:YAG laser welding method is used.

18. The method as set forth in claim 7 further comprising imparting pressure to the bearing liner and backing to ensure proper consolidation of the interface.

19. The method as set forth in claim 7 wherein the prosthetic bearing element is an acetabular cup.
